(19) United States
(12) Patent Application Publication
(10) Pub. No.: US 2006/0174850 A1
(43) Pub. Date: Aug. 10, 2006

(54) Pressure augmentation "(molecular stimulation system)"

(76) Inventor: Edward Edwin Routery, Gilbert, AZ (US)

Correspondence Address: EDWARD EDWIN ROUTERY, 1123 EAST BETSY LN, GILBERT, AZ, 85296, US

(21) Appl. No.: 11/052,175

(22) Filed: Feb. 7, 2005

(51) Int. Cl. F02P 23/00; F02B 1/12; F02D 19/10

(52) U.S. Cl. 123/143 B; 123/27 R

(57) ABSTRACT

An internal or eternal, combustion or steam driven, cylinder assembly includes a cylinder having a combustion and or expansion chamber and a piston An integrated, microprocessor and or sensor, controlled Molecular Stimulator wherein the reservoir core target receives energy on demand, at a preferred frequency and releases said energy sufficient to control temperature in combustion chamber below 2,500 degrees k when emission are a part of the design. When auto-ignition is required it can be obtained as well as best efficiency and combustion. The movement of the core targets shield exposes energy transfer to and from surface areas sufficient for auto-ignition, then allows recharge of energy from combustion event back to reservoir core target before it shuts, allowing remainder of gasses to cool for exhaust cycle.

### REFERENCES CITED [REFERENCED BY]

### U.S. Patent Documents

| | | | |
|---|---|---|---|
| 4462345 | Jul. 31 1984 | Routery | |
| 5156121 | Oct. 20 1992 | Routery | |
| 5245962 | Sep. 21 1993 | Routery | |
| 5724935 | Mar. 10 1998 | Routery | |
| 5752481 | May 1998 | Faulkner | 123/294. |
| 5838906 | November 1998 | Doyle et al. | |
| 6505601 | January 2003 | Jorach et al. | |
| 6561157 | May 2003 | zur Loye et al. | |
| 6637393 | October 2003 | Sutherland. | |
| 2002/0026926 | March 2002 | Loye et al. | |
| 2003/0097998 | May 2003 | Gray, Jr. | |

### BACKGROUND OF THE INVENTION

1. Field of the Invention

The invention relates to internal combustion engines, both Otto and compression ignition.

2. Description of the Related Art

With Ignition Temperatures at Various Air Pressure, ° F. (K) Air pressure, atm

| Gas | (5) | (7) | (10) | (15) | (20) |
|---|---|---|---|---|---|
| Hydrogen* | 1112 | 1100 | | | |
| Methane* | 1215 | 1175 | | | |
| Gasoline | 590 | | 480 | 420 | |
| Kerosene | 670 | | 490 | 430 | 400 |
| Gas oil | 580 | | 500 | 450 | 435 |
| Machine oil | 710 | | 610 | 550 | 520 |

No existing systems provide the control necessary for efficient energy conversion of the above fuels. Hence the theory and technology for accomplishing same is now offered.

### SUMMARY OF THE INVENTION

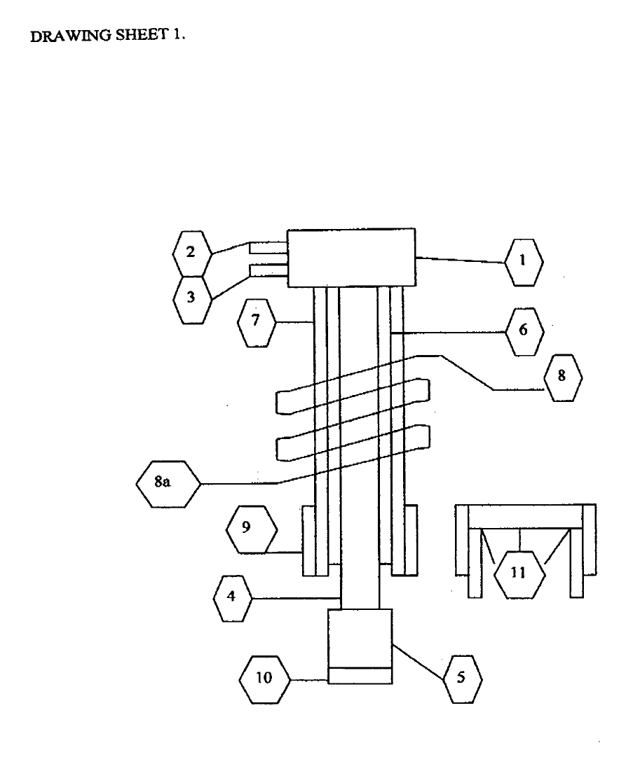

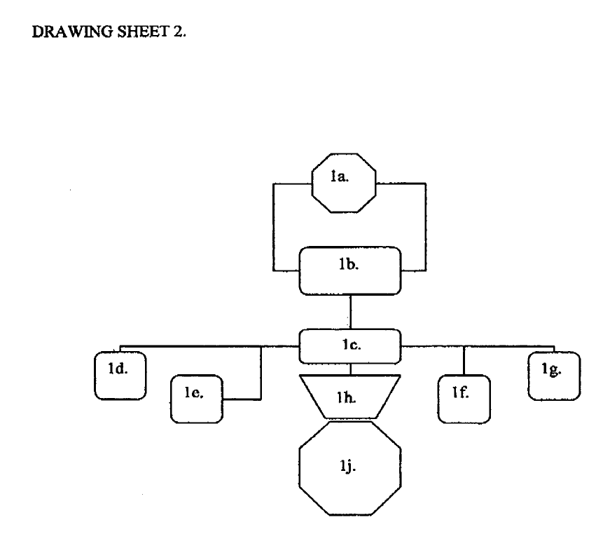

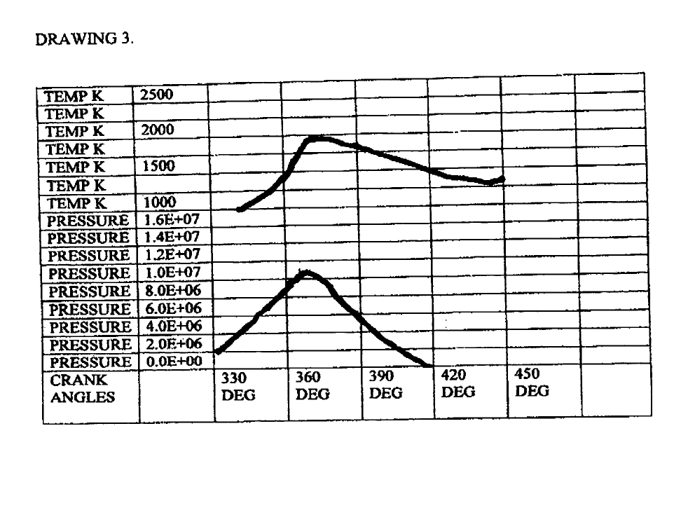

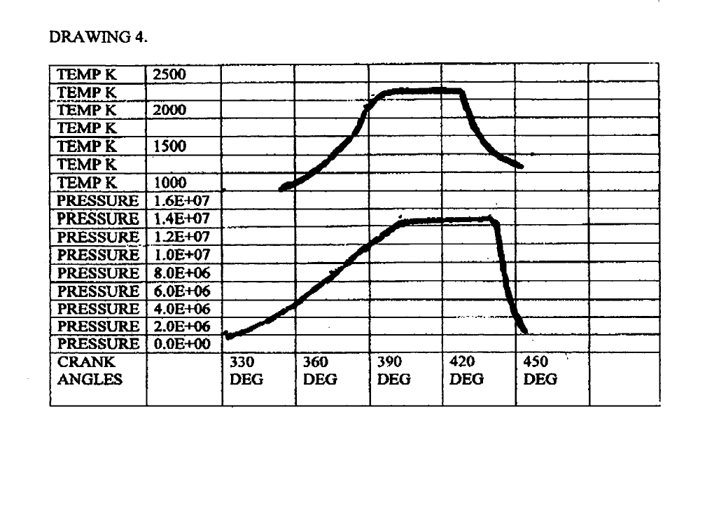

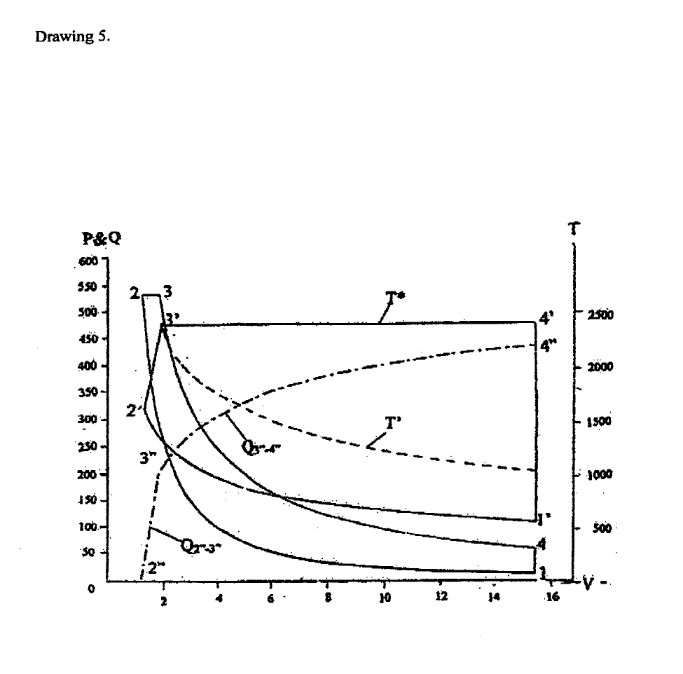

The Molecular stimulator control represents the first real advance in engine operating theory and means for attainment Energy transfer to and from combustion events, providing, temperatures below 2,500 k in time segments sufficient to energize a molecular stimulators reservoir core target, being a containment area volume, for example: 0.200 inch diameter and 3. inch length, containing a mixture of shapes, surface area, and masses, spheres, etc, best arranged for transfer of energy to and from combustion event, in a insulated enclosure, shielded and unshielded on demand, which contains energy for transfer to and from combustion event. Below 2,500 k for reduction of Nox, and combustion duration effects particulates, pollutants, emissions, etc. Temperature control begins at ambient temperature and pressure with the reservoir core target receiving best suited type energy, for assisting compression, towards autos ignition. Temperature, pressure is dependent on, variables, being, thermal, chemical, environmental, mechanical, etc. Variables are controlled by the molecular stimulator circuitry. A contingent of sensing devices, include a sensor internal or external to the combustion event, activating exposure of the energy stored in the reservoir core target at and for a time best suited for preferred combustion, so combustion events occurs in a controlled temperature environment. In Drawing 5 FIG. 1 shows the relationship between pressure and volume, and between temperature and volume of controlled-temperature. With respect to the relationship between pressure and volume, from point 1 to point 2, compression occurs with pressure increasing and volume decreasing. From point 2 to point 3, energy from reservoir core target recharged from a combustion event when available is added at a preferred pressure, providing a preferred temperature T*. From point 3 to point 4, energy is added at a preferred temperature T* until the volume at point 4 is equal to the volume at point 1.

From point 4 returning to point 1, energy recharges reservoir core target while exhausting the combustion chamber. The pressure curve between points 3 and 4 is calculated according to: P(P₃*V₃)N based on ideal gas law. The relationship between temperature and volume, from point 1′ to point 2′, compression occurs, with temperature increasing and volume decreasing. From point 2′ to point 3′, energy is added at a preferred pressure, until temperature T*. From point 3′ to point 4′, energy is added at a preferred temperature T*. To complete the cycle, from point 4′ back to point 1′, energy is removed. FIG. 1 shows the amount of energy required for controlling the temperature of the cycle. In this example, the curve from point 2″ to point 3″, between points 2 and 3, or 2′ and 3′, represents energy as added under preferred pressure being Q2″3″. If energy addition is stopped at point 3′ an adiabatic expansion takes place with temperature dropping along curve T′. To maintain temperature T* from point 3 to point 4, adding energy Q3″-4″ from reservoir core target as needed. It is obvious that Q3″-4″ must equal Cv (T*−T′) as To is the preferred temperature and T′ is the theoretical adiabatic expansion temperature between points 3′ and 4′. As the combustion and expansion processes take place simultaneously, the expansion process is shortened. As a result, the exhaust gas contains thermal energy which recharges the reservoir core target. A molecular stimulator reservoir core target acts as a energy control device, providing a pressure-volume curve defined by points 1-4-1. From point 1 to point 4, pressure is increased by adding energy. From point 4 to point 1 adiabatic expansion causes pressure to decrease while volume increases. The molecular stimulator eliminates NOx formation by selecting an appropriate temperature T* thereby minimizing the formation of particulates and other pollutants. The performance of a molecular stimulator enhanced engine can be predicted using values of pressure and temperature at various points. Assume at point 1, V₁=78. cubic inch, P₁ 14.7 psi, and T1=560 K. With a preferred temperature T* of 2400 K and a compression ratio of 13 is chosen.

At point 2, V2=6. cubic inch, P₂=325 psi, and T2=1562 K. Between points 2 and 3, energy is added, pressure Q2″-3″=6.98 Btu/lbm until the temperature equals T*. At point 3, V₃6. cubic inch, P₃=533 psi, and T₃=2400 K. Between points 3 and 4, energy is added at a preferred temperature of 2400 K, and Q3″-4″=8.19 Btu/lbm. At point 4, V₄=approx 12. cubic inch, P₄=62.9 psi, and T4=2400 K. Between points 4 and 1 recharging molecular stimulator reservoir core target and adiabatic expansion takes place. As point 4 returns to point 1, P4=14.7 psi, and T. returns to 560 K is 57%. Cycle etliciency increases with decreased energy addition and lean burn capability. If combustion is stopped at point 3′, the controlled temperature of molecular stimulator approaches a cycle efficiency of 64.2% with the same pressure ratio. In controlling pressure temperature to and beyond auto-ignition point of preferred fuels, the energy in the reservoir core target is transferred into an or out of the expanding medium increasing temperature of medium or reservoir core target as required, shielding the core target. The control circuitry includes a means for detecting, and generating in preferred patterns, energy for controlled temperature combustion. This invention mounts the molecular stimulator to engine cylinders in a similar manner as sparkplugs and or glow plugs. The molecular stimulator provides the energy to control pressure to auto-ignition at a proscribed crank angle when required, during the combustion and expansion event, providing the most efficient conversion of chemical energy to the most efficient mechanical energy with reduced emissions.

### DETAILED DESCRIPTION OF THE PREFERRED EMBODIMENT

A Molecular Stimulation System according to a first embodiment includes, Circuitry for converting Direct current into a number of frequencies most suitable for molecular stimulation, including but not limited to, induction coils. Each reservoir core target provides energy, sufficient for auto-ignition of fuel in a controlled time and temperature for least pollution emissions. All reservoir core targets are energized to max sustainable energy levels of temperature for controlling combustion events. Each cylinder receives exposure to energy on demand in response to sensors and or operator input, to control temperature which controls pressure into auto-ignition of each fuel. The reservoir core target then partially recharges its energy from combustion gasses prior to total shielding, reducing the need for recharge from induction system as far as Possible, allowing lean burn, reduction of Carbon monoxide, NOx, other pollutants and improving BSFC. Each sensor varies the energy provided to the combustion chamber in response to inputs of rpm, load, operation, cooling, energy transfer coefficients of alloys, of every manufacturers model, year, and production run, and operator input, as patterns of pressure applied at each combustion event are controlled in response to each previous combustion result, making it possible to provide maximum use of energy in a smooth transfer from chemical to mechanical energy.

The advantages of this invention will become apparent to those skilled in the art. Even though this description illustrates a particular design, other designs may be beneficial for other end result uses. It should be understood that various mounting arrangements will benefit from the invention

### BRIEF DESCRIPTION OF THE DRAWINGS

Drawing 1. is a sectionalized view showing a molecular stimulator according to a first embodiment of the present invention, combined to show a preferred sum of segments in the combined view which show a main portion of the Molecular Stimulator and adapter.

Drawing 2. Is a block configuration of the circuitry controlling the Molecular Stimulator.

Drawing 3. Graph taken from test results without Molecular Stimulator.

Drawing 4. Graph taken from test results with Molecular Stimulator.

Drawing 5. Pressure-volume and Temperature-volume diagrams for controlled temperature

Drawing 1 Is a sectional view showing a molecular stimulator according to a first embodiment of the present invention, accompanied by an enlarged view showing a main portion of the molecular stimulator. (1, 2, 3) energizing coil and electrodes for shield adjustment of reservoir core target (4, 5) the energy reservoir core target, transmission medium for energy being transmitted to, resonate to the frequency best suited for Molecular Stimulation of molecules to be energized. (6) material best suited for shielding (5) as well as from (7) material best suited to insulate energy transfer one from the other (8, 8a) the induction coil surrounding a portion of (4) with a gas tight, pressure tight, energy tight seal between (7) and (9) being machined to attach to chamber head in the same method as sparkplugs, (10) insulation, when replacing sparkplugs or glow plugs and (11) adapter for adding volume to decrease pre-ignition when necessary.

Drawing 2. Is a block configuration of the circuitry for the energy to molecular stimulator. (1a.) Represents an energy source, preferably but not limited to, a battery and or alternator, that (1b.) is capable of transforming into various frequencies then sent to (1c.) where in the amplitude of the energy is varied in a pattern using input from (1d.) and (1e.) a load sensor and (1f.) rpm sensor and (Ig.) pressure sensors in each cylinder to initiate energy pattern to the cylinder sensing the appropriate pressure and (1h.) patterns required for each load and rpm of operation. (1g.) the Molecular Stimulator for transferring the desired energy into the field of molecules being stimulated, being various phases of liquid and or gas etc.

Drawing 3. Combustion without Molecular Stimulation.

Drawing 4. Combustion with Molecular Stimulation.

Drawing 5. Pressure-volume and Temperature-volume diagrams for controlled temperature

What is claimed is:

1. In combination with a reciprocating piston apparatus, said apparatus including
a cylinder,
a piston positioned in and operatively associated with said cylinder to define a combustion chamber and to reciprocate through a plurality of positions in said cylinder, said combustion chamber
(i) with a volume, shape, dimension, and pressure for each of said plurality of positions;
(ii) having a volume and pressure which continuously changes when said piston reciprocates in said cylinder;
The improvement comprising controlled temperature, combustion, means by interconnecting said combustion chamber and said molecular stimulator to alter said specific temperatures in said combustion chamber when said piston is in selected positions intermediate of said distal positions and said proximate positions, said controlled temperature a function of the energy provided to said combustion chamber from said molecular stimulator as well as compression energy of mechanical energy (a) said temperature controlled combustion event includes a energy source (1a) connected to a variable frequency output (1b) connected to amplitude circuit (1c) incorporating input from (1d) a load sensor and (1e) a environment sensor and (1f) pressure sensors one for each cylinder and (1g) a rpm sensor and (1h) a combination of preprogrammed and or operator override control device and (1j) one each for each cylinder denoting each molecular stimulator individually.

2. The apparatus of claim 1 wherein
a control of combustion temperature by providing energies;
comprising of various frequencies from (1b) depending on fuels and medium of transmission, and reservoir core target (4) a part of molecular stimulator in use.

3. The apparatus of claim 1 wherein
a control of combustion temperature by providing energies;
comprising a reservoir core target (4, 5) in a volume (6) containing various masses in spherical shapes for providing a preferred alignment of maximum surface area, for efficient transfer of energy to and from combustion event and external source.

4. The apparatus of claim 1 wherein
a control of combustion temperature by providing energies;
comprising a insulation shield (6), installed between reservoir core target and combustion chamber externally adjustable by (1), between exposure providing energy to and or from combustion event and containment of energy within reservoir (4, 5) for maximum energy retention and recharge from energy supplied by power supply system (Ia) through (1h).

5. The apparatus of claim 1 wherein
a control of combustion temperature by providing energies:
comprising of the moveable shield containing insulation properties.

6. The apparatus of claim 1 wherein
a control of combustion temperature by providing energies;
comprising a reservoir core target sufficiently energized prior to exposure to combustion.

7. The apparatus of claim 1 wherein
a control of combustion temperature by providing energies;
comprising a sensor which provides pressure data from said combustion chamber;
for reservoir core target shield to react in proscribed manner to adjustment pressure.

8. The apparatus of claim 1 wherein
a control of combustion temperature by providing energies;
comprising a sensor for controlling molecular stimulator temperature, is mounted internal or external of combustion chamber for monitoring and actuation information gathering, to assist operation of molecular stimulator.

9. The apparatus of claim 1 wherein
a control of combustion temperature by providing energies;
comprising sensors for gathering and response to information gathered

10. The apparatus of claim 1 wherein
a control of combustion temperature by providing energies;
comprising an induction coil to charge reservoir core target.

11. The apparatus of claim 1 wherein
a control of combustion temperature by providing energies;
energizing reservoir core target by resistance heating.

12. The apparatus of claim 1 wherein;
a control of combustion temperature by providing energies;
comprising of laser stimulation heating

13. The apparats of claim 1 wherein;
a control of combustion temperature by providing energies;
comprising connecting a molecular stimulator to a combustion chamber.
